(19) United States
(12) Patent Application Publication
(10) Pub. No.: US 2024/0377287 A1
(43) Pub. Date: Nov. 14, 2024

(54) SYSTEMS, APPARATUSES, AND METHODS FOR SAMPLE CYLINDER INSPECTION, PRESSURIZATION, AND SAMPLE DISPOSAL

(71) Applicant: MARATHON PETROLEUM COMPANY LP, Findlay, OH (US)

(72) Inventors: Alex M. Markins, Findlay, OH (US); Heath B. Jones, Findlay, OH (US); Nicci R. Triche, Findlay, OH (US); John J. Langenfeld, Findlay, OH (US); Masaru F. Williams, Findlay, OH (US); David S. Spence, Findlay, OH (US); Jason M. Chauvin, Findlay, OH (US); Gregory D. Bender, IV, Findlay, OH (US)

(21) Appl. No.: 18/660,290

(22) Filed: May 10, 2024

Related U.S. Application Data
(60) Provisional application No. 63/466,043, filed on May 12, 2023.

(51) Int. Cl. G01N 1/20; G01N 1/22

(52) U.S. Cl. CPC G01N 1/2035; G01N 1/2226; G01N 2001/205; G01N 2001/2085; G01N 2001/2238

(57) ABSTRACT

Systems, apparatuses, and methods for enhancing handling of a sample cylinder may include first, second, and third stations, each configured to receive a sample cylinder containing a material sample. The first station may include a first mounting fixture configured to be attached to the sample cylinder, a viewing glass to facilitate inspection of a portion of the material sample, and a first valve configured to remove a portion of the material sample from the sample cylinder. The second station may include a second mounting fixture and a second valve to provide fluid flow between a source of pressurized gas and the sample cylinder, thereby to pressurize the sample cylinder. The third station may include a third mounting fixture configured to be attached to the sample cylinder and a third valve to provide fluid flow between the sample cylinder and ventilation ductwork or a receptable.

### PRIORITY CLAIM

This U.S. non-provisional patent application claims priority to and the benefit of U.S. Provisional Application No. 63/466,043, filed May 12, 2023, titled “SYSTEMS, APPARATUSES, AND METHODS FOR SAMPLE CYLINDER INSPECTION, PRESSURIZATION, AND SAMPLE DISPOSAL,” the disclosure of which is incorporated herein by reference in its entirety.

### TECHNICAL FIELD

The present disclosure relates to systems, apparatuses, and methods for sample cylinder inspection, pressurization, and sample disposal and, more particularly, to systems, apparatuses, and methods for inspection, pressurization, and sample disposal for sample cylinders containing material samples for testing.

### BACKGROUND

During many chemical manufacturing processes, it may be desirable to periodically determine one or more properties of a material associated with the process. For example, it may be desirable to determine one or more properties of a material associated with the process in order to ensure that the process is proceeding as desired. Material samples may be collected in a sample cylinder, which may be designed to safely contain the material sample until it is tested. For example, a sample of the material may be deposited into the sample cylinder, and the sample cylinder may be taken to a laboratory for testing the material sample. Because the material sample is contained within the sample cylinder, the walls of which are often opaque, it may be difficult to determine the condition and/or contents of the material sample. For example, it may be difficult to determine whether contaminates are present in the sample cylinder. In addition, depending on the form of the material contained in the sample cylinder (e.g., whether the material sample is in liquid form and/or gaseous form), it may be desirable to determine how much of the material sample is contained in the sample cylinder. In addition, it may be desirable to pressurize (or expand) the material sample prior to testing the material sample. In some instances, following testing of the material sample, it may be desirable to prepare the sample cylinder for future use, and thus, it may be desirable to remove any remaining portion of the material sample from the sample cylinder, so that the sample cylinder may be used to collect and contain another material sample without contamination from the material sample that was previously contained in the sample cylinder.

Accordingly, Applicant has recognized a need for enhancing the handling of a sample cylinder to facilitate testing of a material sample contained in the sample cylinder. The present disclosure may address one or more of the above-referenced considerations, as well as other possible considerations.

### SUMMARY

As referenced above, Applicant has recognized that it may be desirable to provide systems, apparatuses, and methods for sample cylinder inspection, pressurization, and/or sample disposal. For example, Applicant has recognized that it may be desirable to provide a way to inspect the contents of a sample cylinder prior to testing the sample material, for example, to determine whether contaminates are present and/or how much of the material sample is contained in the sample cylinder. Applicant has also recognized that in some instances, it may be desirable to change the pressure inside the sample cylinder, depending, for example, on the form of the material sample. Altering the pressure may enhance or facilitate the accuracy of the testing of the material sample. In addition, Applicant has recognized that following testing of the material sample, it may be desirable to remove any of the material sample remaining in the sample cylinder following testing.

The present disclosure generally is directed to systems, apparatuses, and methods for enhancing handling of a sample cylinder for testing a material sample contained in the sample cylinder that may address one or more of the above-mentioned considerations, as well as possibly others. For example, in some embodiments, a system for enhancing handling of a sample cylinder may include one or more stations to facilitate handling of the sample cylinder. For example, in some embodiments, the systems, apparatuses, and methods may facilitate inspection of the contents of the sample cylinder and/or facilitate determination of the amount of the material sample contained in the sample cylinder. In some embodiments, the systems, apparatuses, and methods may facilitate altering the pressure of inside the sample cylinder. In some embodiments, the systems, apparatuses, and methods may facilitate removing any of the material sample remaining in the sample cylinder following testing of the material sample, thereby to reduce the likelihood of contamination of a sample material collected in the sample cylinder following testing of the material sample that was previously contained in the sample cylinder.

In some embodiments, a system for enhancing handling of a sample cylinder may include a platform having a first opening, a second opening, and a third opening. The system further may include a first station positioned to receive a sample cylinder in a first state in which the sample cylinder contains a material sample. The first station may include a first mounting fixture attached to the platform proximate the first opening and configured to be attached to the sample cylinder. The first station further may include an at least partially transparent receptacle configured to be attached to the sample cylinder and facilitate inspection of a portion of the material sample. The first station also may include a first valve positioned proximate the first mounting fixture and configured to provide fluid flow from the sample cylinder, thereby to remove a portion of the material sample from the sample cylinder. The system further may include a second station positioned to receive the sample cylinder in a second state following the first state in which the sample cylinder contains the material sample. The second station may include a second mounting fixture attached to the platform proximate the second opening and configured to be attached to the sample cylinder in the second state. The second station further may include a second valve positioned proximate the second mounting fixture and configured to provide fluid flow between a source of pressurized gas and the sample cylinder, thereby to pressurize the sample cylinder. The system also may include a third station positioned to receive the sample cylinder in a third state following discharge of at least a portion of the material sample from the sample cylinder. The third station may include a third mounting fixture attached to the platform proximate the third opening and configured to be attached to the sample cylinder in the third state. The third station further may include a third valve positioned proximate the third mounting fixture and configured to provide fluid flow between the sample cylinder and one or more of ventilation ductwork or a receptable.

In some embodiments, a system for enhancing handling of a liquid petroleum gas (LPG) sample cylinder may include a platform having a first opening, a second opening, and a third opening. The system further may include a first station positioned to receive an LPG sample cylinder in a first state in which the LPG sample cylinder contains an LPG sample. The first station may include a first mounting fixture attached to the platform proximate the first opening and configured to be attached to the LPG sample cylinder. The first station further may include an at least partially transparent receptacle configured to be attached to the LPG sample cylinder and facilitate inspection of a portion of the LPG sample. The first station also may include a first valve positioned proximate the first mounting fixture and configured to provide fluid flow from the LPG sample cylinder, thereby to remove a portion of the LPG sample from the LPG sample cylinder. The system further may include a second station positioned to receive the LPG sample cylinder in a second state following the first state in which the LPG sample cylinder contains the LPG sample. The second station may include a second mounting fixture attached to the platform proximate the second opening and configured to be attached to the LPG sample cylinder in the second state. The second station further may include a second valve positioned proximate the second mounting fixture and configured to provide fluid flow between a source of pressurized gas and the LPG sample cylinder, thereby to pressurize the LPG sample cylinder. The system also may include a third station positioned to receive the LPG sample cylinder in a third state following discharge of at least a portion of the LPG sample from the sample cylinder. The third station may include a third mounting fixture attached to the platform proximate the third opening and configured to be attached to the LPG sample cylinder in the third state. The third station further may include a third valve positioned proximate the third mounting fixture and configured to provide fluid flow between the LPG sample cylinder and one or more of ventilation ductwork or a receptable.

In some embodiments, a system for enhancing handling of a sample cylinder may include a first station positioned to receive a sample cylinder in a first state in which the sample cylinder contains a material sample. The first station may include an at least partially transparent receptacle configured to be attached to the sample cylinder and facilitate inspection of at least a portion of the material sample, and a first valve positioned to provide fluid flow from the sample cylinder, thereby to remove a portion of the material sample from the sample cylinder. The system further may include a second station positioned to receive the sample cylinder in a second state following the first state in which the sample cylinder contains the material sample. The second station may include a second valve positioned to provide fluid flow between a source of pressurized gas and the sample cylinder, thereby to pressurize the sample cylinder. The system also may include a third station positioned to receive the sample cylinder in a third state following discharge of at least a portion of the material sample from the sample cylinder. The third station may include a third valve positioned to provide fluid flow between the sample cylinder and one or more of ventilation ductwork or a receptable.

In some embodiments, a method for enhancing handling of a sample cylinder may include associating a sample cylinder containing a material sample with a system for handling a sample cylinder. The method further may include inspecting the material sample contained in the sample cylinder, and pressurizing the material sample in the sample cylinder. The method also may include connecting the sample cylinder to a ventilation hood, thereby to provide selective fluid flow from the sample cylinder to the ventilation hood, and purging the material sample from the sample cylinder, thereby to release at least a portion of material sample to the ventilation hood.

In some embodiments, a method for enhancing handling of a sample cylinder may include connecting a first end of a sample cylinder containing a material sample with a first connector connected to a platform to facilitate inspection of the material sample. The method further may include connecting a second end of the sample cylinder to an at least partially transparent receptacle to facilitate inspection of the material sample. The method also may include disconnecting the second end of the sample cylinder from the at least partially transparent receptacle and disconnecting the first end of the sample cylinder from the first connector. The method further may include connecting the sample cylinder to a second connector connected to the platform, the second connector being in fluid communication with a gas supply valve positioned to provide fluid flow between a source of pressurized gas and the second connector. The method also may include opening the gas supply valve to pressurize the material sample in the sample cylinder. The method further may include closing the gas supply valve to prevent fluid flow between the source of pressurized gas to the second connector. The method also may include disconnecting the sample cylinder from the second connector and connecting one of the first end of the sample cylinder or the second end of the sample cylinder to a third connector connected to the platform, the third connector being in fluid communication with a ventilation hood. The method further may include purging the material sample from the LPG sample cylinder, thereby to release at least a portion of the material sample to the ventilation hood.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1 is a schematic front perspective view from a first angle of an example system for enhancing handling of a sample cylinder, according to embodiments of the disclosure.

FIG. 2 is a schematic front perspective view from a second angle of the example system for enhancing handling of a sample cylinder shown in FIG. 1, according to embodiments of the disclosure.

FIG. 3 is a schematic front perspective view from a third angle of the example system for enhancing handling of a sample cylinder shown in FIG. 1, according to embodiments of the disclosure.

FIG. 4A is a schematic front perspective view of the example system for enhancing handling of a sample cylinder shown in FIG. 1 with an example sample cylinder mounted to an example first station of the system, according to embodiments of the disclosure.

FIG. 4B is a schematic front perspective view of the example system for enhancing handling of a sample cylinder shown in FIG. 1 with an example sample cylinder mounted to an example second station of the system, according to embodiments of the disclosure.

FIG. 4C is a schematic front perspective view of the example system for enhancing handling of a sample cylinder shown in FIG. 1 with an example sample cylinder mounted to an example third station of the system, according to embodiments of the disclosure.

FIG. 5 is a schematic front perspective view of another example system for enhancing handling of a sample cylinder, according to embodiments of the disclosure.

FIG. 6A is a block diagram of an example method for enhancing handling of a sample cylinder, according to embodiments of the disclosure.

FIG. 6B is a continuation of the block diagram shown in FIG. 6A, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

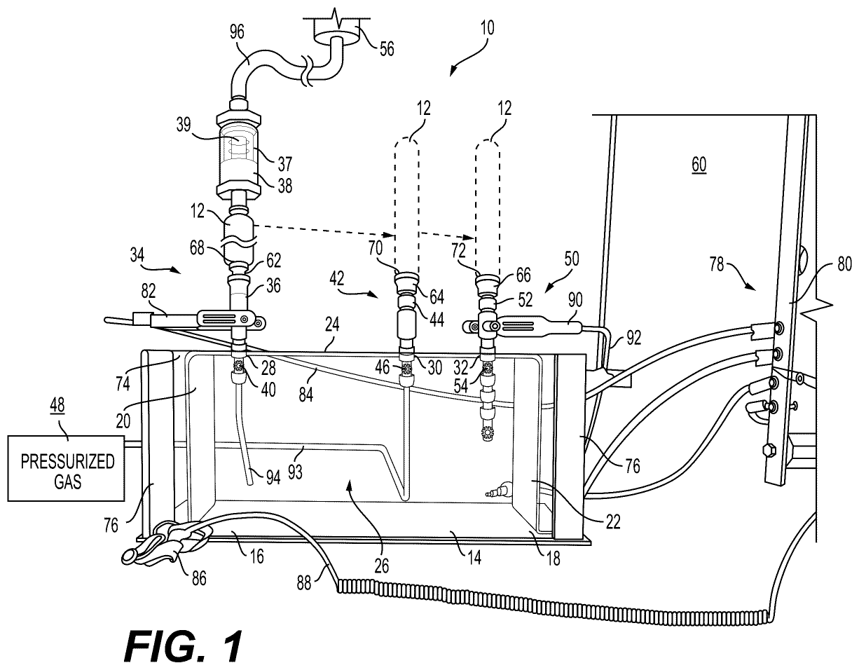

FIG. 1 schematically illustrates a front perspective view from a first angle of an example system 10 for enhancing handling of a sample cylinder 12 containing a material sample, according to embodiments of the disclosure. For example, the sample cylinder 12 may contain a material sample extracted from a chemical manufacturing process. As noted herein, it may be desirable to periodically determine one or more properties of a material associated with the process in order to ensure that the process is proceeding as desired. Material samples may be collected in the sample cylinder 12, which may be designed to safely contain the material sample until it is tested. For example, a sample of the material may be deposited into the sample cylinder 12, and the material sample may be tested to determine one or more properties of interest. For example, the sample material may be tested via testing equipment located proximate the location from which the material sample was collected, and/or the sample cylinder 12 may be transferred to a laboratory setting for testing the material sample, for example, as will be understood by those skilled in the art. For example, the sample cylinder 12 may contain a sample of liquid petroleum gas (LPG). Although some examples discussed herein may refer to material samples that include LPG, material samples including other materials are contemplated.

Applicant has recognized that for the purpose of improving the accuracy of testing a material sample, it may be desirable to inspect a sample cylinder containing a material sample for: (1) the presence of contaminates such as water and particulates in the material sample, and (2) the amount of the material sample contained in the sample cylinder 12. For example, contaminants in the sample cylinder may adversely affect the testing results and/or may foul testing instrumentation, and thus, it may be desirable to remove contaminates from the sample cylinder 12 prior to testing. In addition, depending on the form of the material sample (e.g., whether it is in gaseous or liquid form), if the volume of the amount of the material sample is greater than a certain percentage of the volume of the sample cylinder (e.g., greater than about 75%), a potentially hazardous condition may be created. For example, if the sample material is LPG and the temperature of the sample cylinder is increased, the volume of the LPG sample may grow to exceed the capacity of the sample cylinder, which may result in the sample cylinder rupturing.

Applicant has also recognized that once contaminates have been removed from the sample cylinder and the amount material sample contained in the sample cylinder is below the maximum desired amount, the sample cylinder may be prepared for transfer of the material sample from the sample cylinder into testing instrumentation. This may include pressurizing the material sample in the sample cylinder to ensure that the material sample is in liquid form for testing by the testing instrumentation. For example, if the material sample includes LPG, this may include pressurizing the LPG in the LPG sample cylinder to ensure that the LPG is in liquid form for testing by the testing instrumentation. In some embodiments, pressurization of the material sample may include pumping inert gas into the sample cylinder at a pressure of, for example, about 400 pounds per square inch or greater. Following use of the sample cylinder for testing, Applicant has recognized that it may be desirable to purge the sample cylinder to remove any portion of the material sample from the sample cylinder to prepare it for use for collection and testing of another material sample. For example, if the material sample includes LPG, it may be desirable to purge any portion of the LPG sample remaining in the sample cylinder following testing. This may include, for example, LPG and other petroleum cuts still present in the sample cylinder following testing.

In some embodiments, the system 10 for enhancing handling of a sample cylinder 12 may include a single integrated multi-station apparatus that may be used to perform the following one or more of the following four functions: (1) inspecting the sample cylinder 12 for contaminates; (2) ensuring that the sample cylinder 12 contains less than a predetermined maximum volume of the material sample relative to the total volume of the sample cylinder 12 (e.g., an amount ranging from less than about 75% to less than about 90%, for example, less than about 80%, of the total volume of the sample cylinder 12); (3) pressurizing the sample cylinder 12 to prepare it for being used to transfer material samples from the sample cylinder 12 into testing instrumentation; or (4) following use of the sample cylinder 12 for testing, venting any remaining gaseous contents of the sample cylinder 12 to a laboratory ventilation hood ductwork and removing any remaining liquid contents from the sample cylinder 12.

As shown in FIG. 1, in some embodiments, the system 10 for enhancing handling of the sample cylinder 12 may include a base 14 having a first end 16 and a second end 18 opposite the first end 16. The system 10 further may include a first upright 20 connected proximate the first end 16 of the base 14, and a second upright 22 connected proximate the second end 18 of the base 16. In some embodiments, a platform 24 may be connected to the first upright 20 and the second upright 22, thereby to provide a space 26 between the base 14 and platform 24. In some embodiments, the platform 24 may include a first opening 28, a second opening 30, and a third opening 32, each extending through the platform 24.

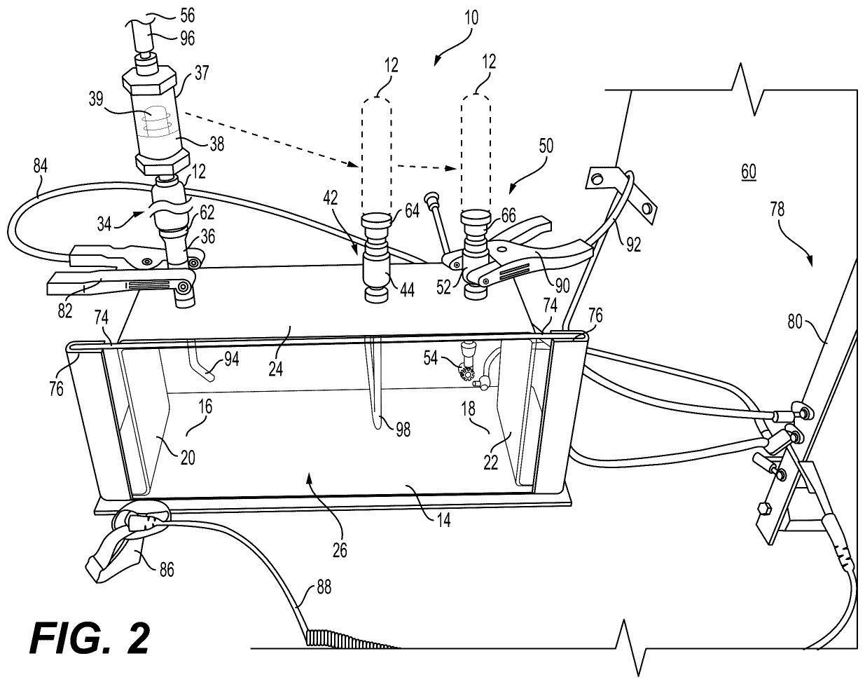

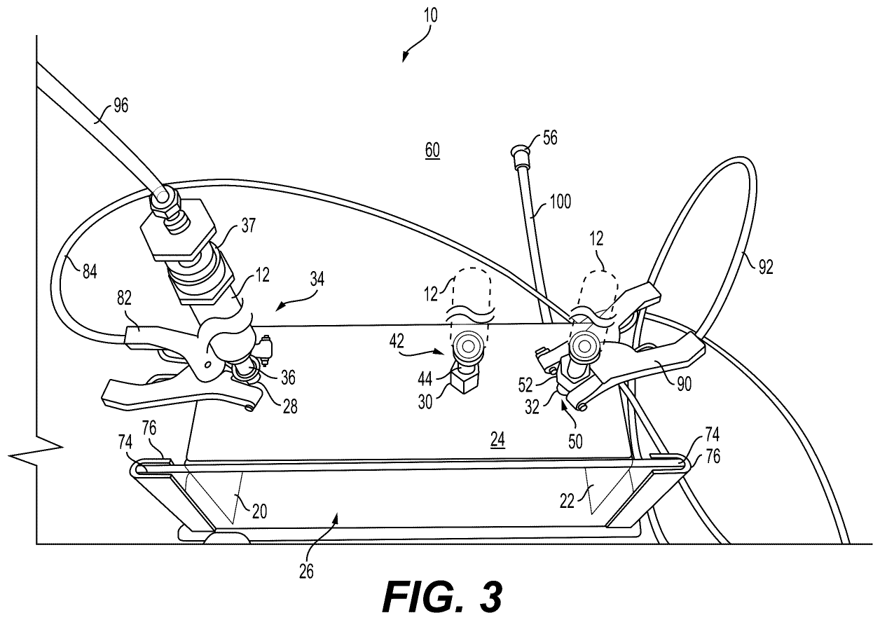

FIG. 2 is a schematic front perspective view from a second angle (e.g., different than the first angle of FIG. 1) of the example system 10 for enhancing handling of a sample cylinder 12 shown in FIG. 1, and FIG. 3 is a schematic front perspective view from a third angle (e.g., different than the first angle of FIG. 1 and the second angle of FIG. 2) of the example system 10 for enhancing handling of the sample cylinder 12 shown in FIG. 1. As shown in FIGS. 1-3, the system 10 may include a first station 34 positioned to receive a sample cylinder 12, for example, in a first state in which the sample cylinder 12 contains a material sample (e.g., an LPG sample). In some embodiments, the first station 34 may include a first mounting fixture 36 attached to the platform 24 proximate the first opening 28 and configured to be attached to the sample cylinder 12 (e.g., an LPG sample cylinder). The first station 34 further may include an at least partially transparent receptacle 37 (e.g., a viewing glass) configured to be attached the sample cylinder 12 and facilitate inspection of a portion of a material sample 38. For example, the sample cylinder 12 may be opaque (e.g., formed from metal such as aluminum and/or stainless steel), and the at least partially transparent receptacle 37 may be configured to receive a portion of the material sample 38 therein, thereby to facilitate a visual inspection of the portion of the material sample 38 viewable in the at least partially transparent receptacle 37. In some embodiments, the at least partially transparent receptacle 37 may be substantially vertically oriented (e.g., a longitudinal axis of the at least partially transparent receptacle 37 may be substantially perpendicular relative to the base 14), for example, as shown in FIGS. 1 and 2. The at least partially transparent receptacle 37 may include any known receptacle facilitating a visual inspection of the portion of the material sample 38. In some embodiments, a flow meter 39 may be provided, for example, in the at least partially transparent receptacle 37, and the flow meter 39 may be configured to provide one or more flow signals indicative of the flow rate of fluid (e.g., a liquid) through the at least partially transparent receptacle 37.

As shown in FIGS. 1-3, in some embodiments, the first station 34 may include a first valve 40 positioned proximate the first mounting fixture 36 and opposite the platform 24 relative to the sample cylinder 12, for example, when a sample cylinder 12 is mounted to the first mounting fixture 36. The first valve 40 may be configured to provide fluid flow between the sample cylinder 12 and the space 26, thereby to remove a portion of the material sample from the sample cylinder 12.

As shown in FIGS. 1-3, the system 10 further may include a second station 42 positioned to receive the sample cylinder 12 in a second state following the first state, for example, in which the sample cylinder 12 contains the material sample 38. In some embodiments, the second station 42 may include a second mounting fixture 44 attached to the platform 24 proximate the second opening 30 and configured to be attached to the sample cylinder 12 in the second state. The second station 42 also may include a second valve 46 positioned proximate the second mounting fixture 44 and opposite the platform 24 relative to the sample cylinder 12, for example, when a sample cylinder 12 is mounted to the second mounting fixture 44, and configured to provide fluid flow between a source of pressurized gas 48 and the sample cylinder 12, thereby to pressurize the sample cylinder 12.

In some embodiments, as shown in FIGS. 1-3, the system 10 further may include a third station 50 positioned to receive the sample cylinder 12 in a third state, for example, following discharge of at least a portion of the material sample 38 from the sample cylinder 12. In some embodiments, the third station 50 may include a third mounting fixture 52 attached to the platform 24 proximate the third opening 32 and configured to be attached to the sample cylinder 12 in the third state. The third station 50 further may include a third valve 54 positioned proximate the third mounting fixture 52 and opposite the platform 24 relative to the sample cylinder 12, for example, when a sample cylinder 12 is mounted to the third mounting fixture 52, and configured to provide fluid flow between the sample cylinder 12 and one or more of ventilation ductwork 56 or a receptable 58, such as, for example, ventilation ductwork associated with a ventilation hood and a beaker or flask, respectively, for receipt of portions of the material sample 38.

As shown in FIGS. 1-3, in some embodiments, two or more of the first station 34, the second station 42, or the third station 50 may form a single, integrated apparatus to perform one or more of the above-noted functions related to handling of a sample cylinder 12. For example, the system 10, in some embodiments, may be situated and used in a standard laboratory ventilation hood space 60 to increase the efficiency of handling of the sample cylinder and the material sample 38. Although schematically depicted in FIGS. 1-3 as being relatively short, the sample cylinders may range in length, for example, from about 10 inches to about 30 inches (e.g., from about 18 inches to about 20 inches).

In some embodiments, the system 10 may include a first boss 62, a second boss 64, and a third boss 66, each connected to the platform 24 and providing fixtures for receipt of a sample cylinder 12, as shown, at each of the first station 34, second station 42, and third station 50, respectively. One or more of the first boss 62, the second boss 64, or the third boss 66, in addition to providing respective passages through the platform 24 via the first opening 28, the second opening 30, and third opening 32, respectively, may be respectively provided with a first cylinder mount 68, a second cylinder mount 70, and a third cylinder mount 72, which may each include a quick-connect connector configured to facilitate ease of connection to a corresponding quick-connect connector mounted to an end of the sample cylinder 12. As a result, the sample cylinder 12, in at least some embodiments, may be quickly connected and quickly disconnected to each of the first, second, and/or third cylinder mounts 68, 70, and/or 72, for example, as the sample cylinder 12 progresses through two or more of the above-noted functions and undergoes, for example, inspection at the first station 34, pressurization at the second station 42, and/or venting and/or purging at the third station 50.

As shown in FIGS. 1-3, some embodiments of the system 10 also may include a shield 74, for example, to protect a laboratory technician from emission of contents from the sample cylinder 12 during handling. In some embodiments, the shield 74 may be formed from a translucent or transparent material (e.g., plexiglass) to enable a technician to see through the shield when facing the system 10. The shield 74, in some embodiments, may be slidably mounted to the system 10 via two upright support slots 76 connected to opposite ends of the base 14. The support slots 76 may facilitate removal and cleaning of the shield 74, for example, when the shield 74 becomes soiled from materials emitted from the sample cylinder 12, for example, as explained herein.

As shown in FIGS. 1-3, in some embodiments, the system 10 further may include a grounding assembly 78 positioned to electrically ground a technician handling the sample cylinder 12, the first station 34, the second station 42, and/or the third station 50. For example, the grounding assembly 78 may include an electrically grounded connection bus 80, for example, a copper bus bar electrically grounded to a suitable grounding device associated with the ventilation hood space 60. In some embodiments, the grounding assembly 78 may include a first clamp 82 configured to be attached to the first station 34, the second station 42, and/or the third station 50. The first clamp 82 may be electrically conductive. The grounding assembly 78 further may include a first cable 84 connected to the first clamp 82 and the electrically grounded connection bus 80. The first cable 84 may be electrically conductive. The grounding assembly 78 also may include a wearable attachment 86 configured to be attached to the technician handling the sample cylinder 12, and the wearable attachment 86 may be electrically conductive. The grounding assembly 78 further may include a second cable 88 connected to the wearable attachment 86 and the electrically grounded connection bus 80, and the second cable 88 may be electrically conductive. In some embodiments, the wearable attachment 86 may include a wrist strap for electrically grounding the technician. The system 12 further may include ground connections for electrically connecting to the first, second, and/or third bosses 62, 64, and/or 66, and/or to other metallic components associated with each of the first, second, and/or third stations 34, 42, and/or 50, to the connection bus 80 to electrically ground each of the stations. In some embodiments, this may reduce the likelihood or prevent generation of sparks associated with the technician and the stations, which may reduce the likelihood or prevent ignition of any volatile fumes that may be present under the ventilation hood space 60. In some embodiments, the grounding assembly 78 may include a second clamp 90 configured to be attached to the first station 34, the second station 42, and/or the third station 50. The second clamp 90 may be electrically conductive. The grounding assembly 78 further may include a third cable 92 connected to the second clamp 92 and the electrically grounded connection bus 80. The third cable 92 may be electrically conductive. Additional clamps and corresponding cables are contemplated.

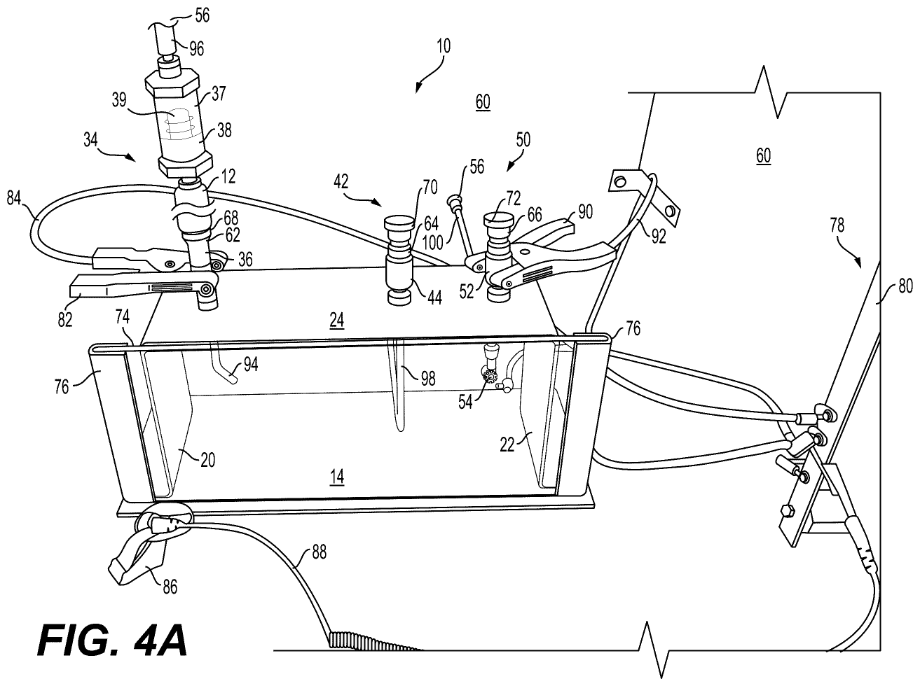

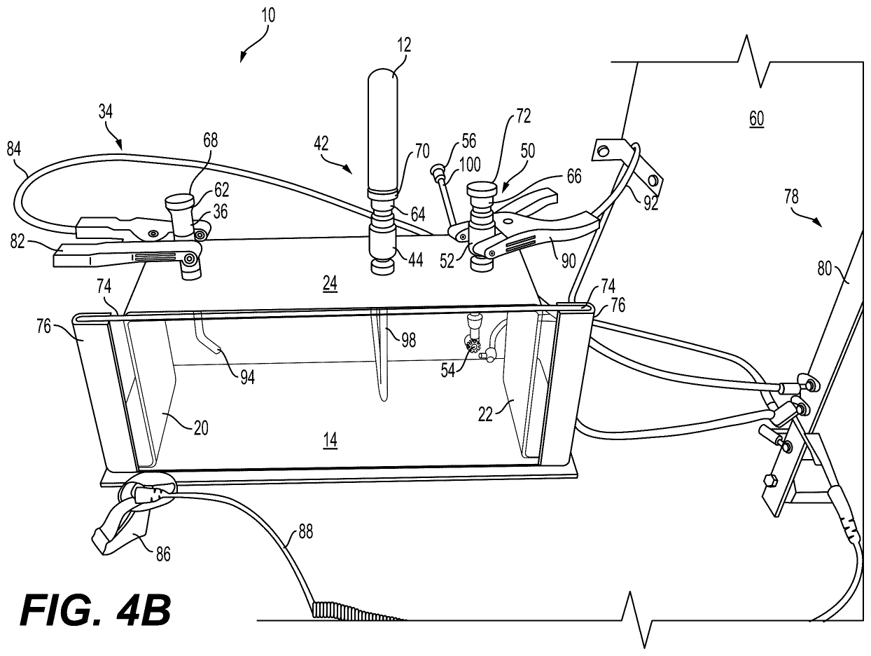

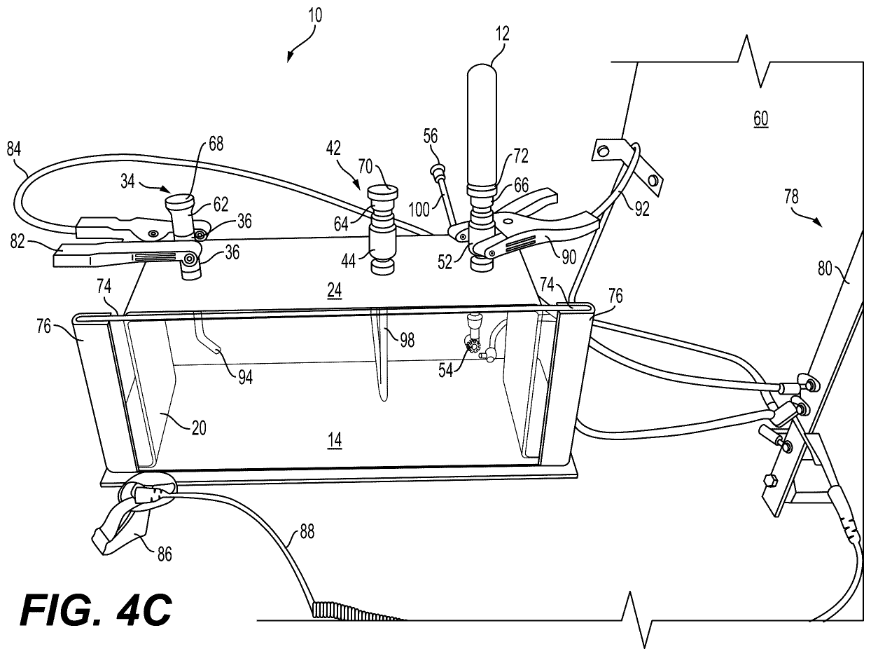

FIG. 4A is a schematic front perspective view of the example system for enhancing handling of the sample cylinder 12 shown in FIG. 1, with an example sample cylinder 12 mounted to an example first station 34 of the system 10, according to embodiments of the disclosure. FIG. 4B is a schematic front perspective view of the example system 10 for enhancing handling of the sample cylinder 12 shown in FIG. 1, with an example sample cylinder 12 mounted to an example second station 42 of the system 12, according to embodiments of the disclosure. FIG. 4C is a schematic front perspective view of the example system 10 for enhancing handling of the sample cylinder 12 shown in FIG. 1, with an example sample cylinder 12 mounted to an example third station 50 of the system 10, according to embodiments of the disclosure.

As schematically depicted in FIGS. 4A-4C, a sample cylinder 12 may be moved between one or more of the first station 34, the second station 42, or the third station 50, for example, as the technician performs one or more of the functions described herein. For example, as shown in FIG. 4A, the technician may use the first cylinder mount 68 (e.g., a quick-connect connector) to mount the sample cylinder 12 to the first boss 62, and the technician may mount the at least partially transparent receptacle 37 to the upper end of the sample cylinder 12, for example, using an additional quick-connect connector. In some embodiments, at the first station 34, the technician may use the at least partially transparent receptacle 37 to inspect whether the sample cylinder 12 contains a greater volume of the material sample 38 (e.g., an LPG sample) than a predetermined maximum volume relative to the volume of the sample cylinder 12. This may range from less than about 75% to less than about 90%, for example, less than about 80%, of the total volume of the sample cylinder 12. If so, the technician may open the first valve 40, which may be located below the platform 24, to allow a portion of the contents of the sample cylinder 12 to drain via a bleed tube 94 below the platform 24 and above the base 14 until the desired amount of the material sample 38 contained in the sample cylinder 12 is achieved. The bleed tube 94 may be located behind the shield 74 and/or may be angled away from the shield 74, for example, to reduce the likelihood that the material bled from the sample cylinder 12 is directed toward the technician. The shield 74 also may serve to protect the technician from exposure to the material exiting the bleed tube 94. A receptacle, such as a beaker or flask, may receive the material bled from the sample cylinder 12, and the material may be inspected for contaminates, such as water and particulates.

In some embodiments, the technician also may use at least partially transparent receptacle 74 to inspect whether the sample cylinder 12 contains any contaminates, such as particulates, sludge, or water. In addition, a vent tube 96 (e.g., a translucent or transparent vent tube) may be provided at the top of the at least partially transparent receptacle 37 to vent any gaseous material from the sample cylinder 12. The vent tube 96 may be connected to the ductwork 56 of the ventilation hood 60 to reduce the likelihood or prevent any vented gaseous material from being expelled into the area surrounding the system 12. For example, the sample cylinder may contain caustic materials, such as hydrogen sulfide, which, if expelled under the ventilation hood 60 in an uncontrolled manner, could result in exposure of the technician to the caustic materials.

According to some embodiments, once the technician has verified the absence of contaminates, or removed them via the bleed tube 94 and/or the vent tube 96, and ensured that the sample amount is below the predetermined maximum amount, or removed some of the material sample 38, the technician may disconnect the sample cylinder 12 from the first cylinder mount 68 to unmount the sample cylinder 12 from the first boss 62, and disconnect the upper end of the sample cylinder 12 from the at least partially transparent receptacle 37 (e.g., via disconnection of a quick-connect connector). As shown in FIG. 4B, the technician may use the second cylinder mount 70 (e.g., a quick-connect connector) to mount the sample cylinder 12 to the second boss 64. In some embodiments, as discussed herein, the lower end of the second boss 64 may be connected to the second valve and the supply of pressurized gas 48 (see FIG. 1), which may be used to pressurize the sample cylinder 12, for example, to prepare it for transfer of at least a portion of the material sample 38 into testing instrumentation for testing the contents of the sample cylinder 12. For example, a gas supply line 98 may be connected to the supply of pressurized gas 48, which may be an inert gas, such as nitrogen, and the technician may open the second valve 46 to supply pressurized gas to the sample cylinder 12, which may increase the likelihood or ensure that the material sample 38 (e.g., an LPG sample) in the sample cylinder 12 is in liquid form for testing. Once the sample cylinder 12 has been pressurized to a desired pressure (e.g., about 400 psi), the technician may close the second valve 46 and separate the sample cylinder 12 from the second boss 64 of the second station 42, for example, using a quick-connect connector, and transfer the prepared (e.g., pressurized) sample cylinder 12 to testing instrumentation for desired sample testing.

Following the sample testing, as shown in FIG. 4C, the technician may use the third cylinder mount 72 (e.g., a quick-connect connector) to mount the sample cylinder 12 to the third boss 66 of the third station 50 for venting or purging any remaining contents of the sample cylinder 12 to the ductwork 56 of the ventilation hood 60 (e.g., gaseous contents) and/or to a receptacle (e.g., liquid contents). In some embodiments, as discussed herein, the lower end of the third boss 66 may be connected to the third valve 54 under the platform 24 and above the base 14. For example, the third valve 54 may include a T-valve that may be operated to cause gaseous material remaining in the sample cylinder 12 to flow directly to the ventilation hood ductwork 56 (via a vent line 100) (see FIG. 3). In some embodiments, a T-valve also may be operated to cause any liquid material (e.g., heavier petroleum cuts, such as pentanes and hexanes) to flow from the sample cylinder 12 and through the T-valve to a receptacle under the T-valve, such as a beaker or flask for collecting the liquid material.

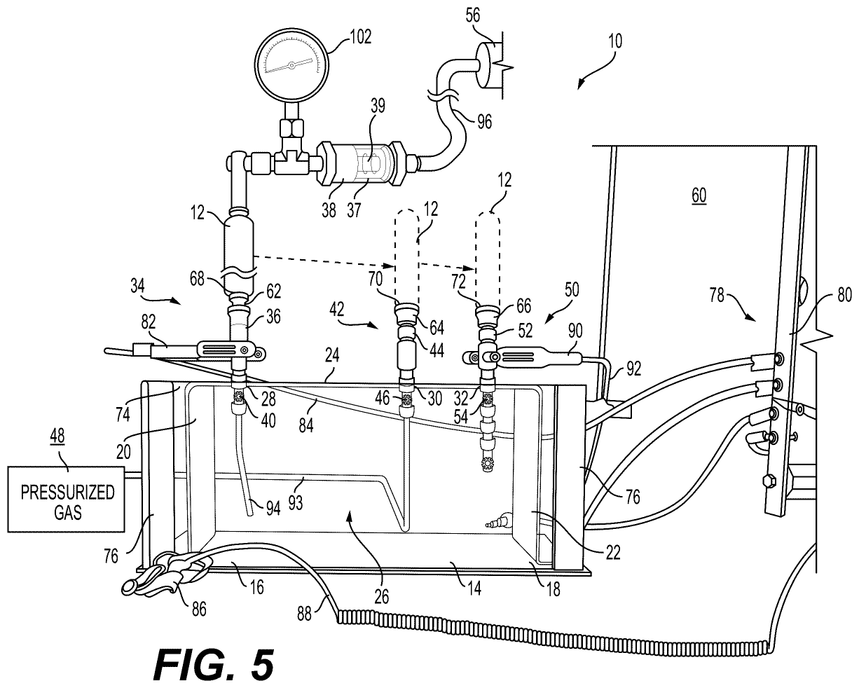

FIG. 5 schematically illustrates a front perspective view of another example system 10 for enhancing handling of a sample cylinder 12 containing a material sample, according to embodiments of the disclosure. In some embodiments, the at least partially transparent receptacle 37 may be substantially horizontally oriented (e.g., such that a longitudinal axis of the at least partially transparent receptacle 37 is substantially parallel relative to the base 14), for example, as shown in FIG. 5. The orientation (e.g., the example horizontal orientation) may render it relatively easier, for example, as compared to a substantially vertical orientation (see, e.g., FIG. 1) to view fluid (e.g., a liquid) passing through the at least partially transparent receptacle 37. In some embodiments, a flow meter 39 may be provided, for example, in the at least partially transparent receptacle 37, and the flow meter 39 may be configured to provide one or more flow signals indicative of the flow rate of fluid (e.g., a liquid) through the at least partially transparent receptacle 37. In some embodiments, a flow meter may be omitted, which may render it relatively easier, for example, as compared to embodiments including a flow meter, to view fluid (e.g., a liquid) passing through the at least partially transparent receptacle 37.

As shown in FIG. 5, some embodiments of the example system 10 may include a pressure gauge 102 configured to indicate the pressure between the sample cylinder 12 and the at least partially transparent receptacle 37. For example, the pressure gauge 102 may be in flow communication with the sample cylinder 12 and/or the at least partially transparent receptacle 37. Provision of a pressure gauge at one or more other locations of the system 10 is contemplated.

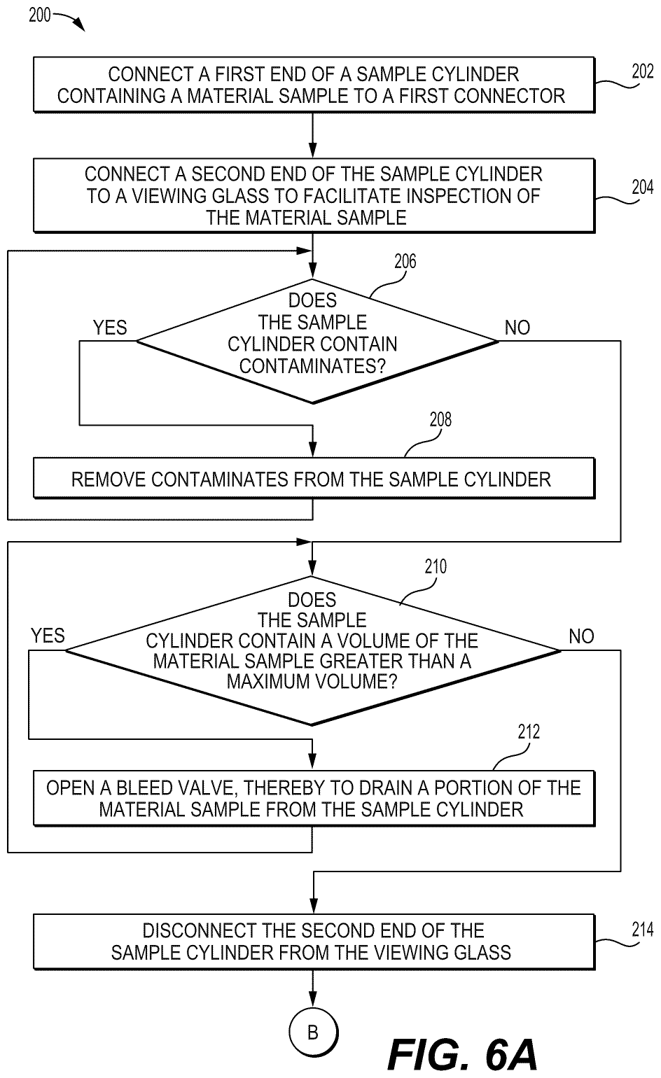

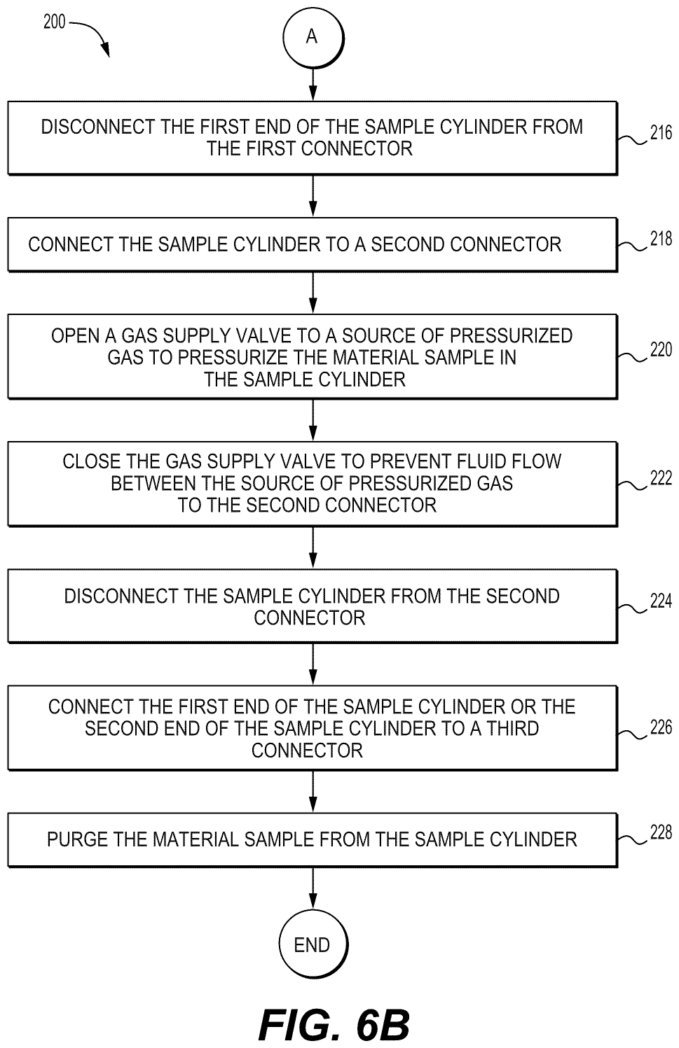

FIG. 6A and FIG. 6B are a block diagram of an example method 200 for enhancing handling of a sample cylinder, according to embodiments of the disclosure. The example method 200 is illustrated as collections of blocks in a logical flow graph, which represent a sequence of operations. In the context of software, where applicable, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the methods.

FIGS. 6A and 6B are a block diagram of an example method 200 for enhancing handling of a sample cylinder containing a material sample, according to embodiments of the disclosure. In some embodiments, the sample cylinder may be an LPG sample cylinder containing an LPG sample. At 202, the example method 200 may include connecting a first end of a sample cylinder containing a material sample with a first connector connected to a platform to facilitate inspection of the material sample, for example, as described herein.

At 204, the example method 200 may include connecting a second end of the sample cylinder to an at least partially transparent receptacle (e.g., a viewing glass) to facilitate inspection of the material sample, for example, as described herein.

The example method 200, at 206, may include determining whether the sample cylinder contains contaminates, for example, as described herein. For example, the at least partially transparent receptacle may be used to determine whether the sample cylinder contains one or more of particulates, sludge, or water, for example, as described herein.

If, at 206, it is determined that the sample cylinder contains contaminates, the example method 200, at 208, may include removing contaminates from the sample cylinder. For example, a gaseous portion of the material sample may be vented via a vent tube connected to the at least partially transparent receptacle and a ventilation hood, for example, as described herein. In some examples, a liquid and/or solid portion of the contaminates may be bled from the sample cylinder via a bleed tube, for example, via operation of a bleed valve, as described herein. Thereafter, the example method 200 may include advancing to 210, once it is determined that the material sample is sufficiently free of contaminates.

If, at 206, it is determined that the sample cylinder does not contain contaminates, the example method 200, at 210, may include determining whether the sample cylinder contains a greater volume of the material sample than a predetermined maximum volume relative to the volume of the sample cylinder, for example, as described herein.

If, at 210, it is determined that the sample cylinder contains a greater volume of the material sample than a predetermined maximum volume relative to the volume of the sample cylinder, the example method 200, at 212, may include opening a bleed valve, thereby to drain a portion of the material sample from the sample cylinder until the volume of the material sample is less than the predetermined maximum volume, for example, as described herein. Thereafter, once it is determined that the sample cylinder no longer contains a greater volume of the material sample than the predetermined maximum volume relative to the volume of the sample cylinder, the example method 200 may include advancing to 214.

If, at 210, it is determined that the sample cylinder does not contain a greater volume of the material sample than the predetermined maximum volume relative to the volume of the sample cylinder, the example method 200, at 214, may include disconnecting the second end of the sample cylinder from the at least partially transparent receptacle, for example, as described herein.

At 216 (FIG. 6B), the example method 200 may include disconnecting the first end of the sample cylinder from the first connector, for example, as describe herein.

The example method 200, at 218, may include connecting the sample cylinder to a second connector connected to the platform, for example, as described herein. In some embodiments, the second connector may be in fluid communication with a gas supply valve positioned to provide fluid flow between a source of pressurized gas and the second connector.

At 220, the example method 200 may include opening the gas supply valve to pressurize the material sample in the sample cylinder, for example, as described herein. This may serve to ensure that the material sample is in liquid form ready for testing, for example, if the material sample is an LPG sample or similar sample.

The example method 200, at 222, may include closing the gas supply valve to prevent fluid flow between the source of pressurized gas to the second connector, for example, as described herein.

At 224, the example method 200 may include disconnecting the sample cylinder from the second connector, for example, as described herein. In some embodiments, the sample cylinder may be separated from the second connector for testing the material sample via sample testing equipment. For example, the sample cylinder may be ready to be used to test one or more properties of the material sample, for example, via material testing equipment, as will be understood by those skilled in the art.

The example method 200, at 226, following testing of the material sample, may include connecting the first end of the sample cylinder or the second end of the sample cylinder to a third connector connected to the platform, for example, as described herein. In some embodiments, the third connector may be in fluid communication with a ventilation hood, for example, as described herein.

At 228, the example method 200 may include purging the material sample from the sample cylinder, thereby to release at least a portion of the material sample to the ventilation hood, for example, as described herein. For example, purging the material sample from the sample cylinder may include operating a purge valve, thereby to cause gaseous material remaining in the sample cylinder to flow directly to ductwork of the ventilation hood via a vent line. In some embodiments, purging the material sample from the sample cylinder may include operating a purge valve, thereby to cause to cause liquid material in the sample cylinder to flow from the sample cylinder and through a T-valve to a receptacle positioned to collect the liquid material, for example, as described herein.

In some embodiments, the example method 200 may further include electrically connecting the platform, the first connector, the second connector, and/or the third connector to a grounded bus bar, thereby to electrically ground the platform, for example, as described herein. In some embodiments, the example method 200 may include electrically connecting a person handling the sample cylinder to a grounded bus bar, thereby to electrically ground the person, for example, as described herein. For example, electrically connecting the person handling the sample cylinder to the grounded bus bar may include attaching an electrically conductive strap to the person and the grounded bus bar, for example, as described herein.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This U.S. non-provisional patent application claims priority to and the benefit of U.S. Provisional Application No. 63/466,043, filed May 12, 2023, titled “SYSTEMS, APPARATUSES, AND) METHODS FOR SAMPLE CYLINDER INSPECTION, PRESSURIZATION, AND SAMPLE DISPOSAL,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiments, and numerous variations, modifications, and additions further may be made thereto without departing from the spirit and scope of the present disclosure as set forth in the appended claims.

What is claimed is:

1. A system for enhancing handling of a sample cylinder, the system comprising:
a platform having a first opening, a second opening, and a third opening;
a first station positioned to receive a sample cylinder in a first state in which the sample cylinder contains a material sample, the first station comprising:
a first mounting fixture attached to the platform proximate the first opening and configured to be attached to the sample cylinder;
an at least partially transparent receptacle configured to be attached to the sample cylinder and facilitate inspection of a portion of the material sample; and
a first valve positioned proximate the first mounting fixture and configured to provide fluid flow from the sample cylinder, thereby to remove a portion of the material sample from the sample cylinder;
a second station positioned to receive the sample cylinder in a second state following the first state in which the sample cylinder contains the material sample, the second station comprising:
a second mounting fixture attached to the platform proximate the second opening and configured to be attached to the sample cylinder in the second state; and
a second valve positioned proximate the second mounting fixture and configured to provide fluid flow between a source of pressurized gas and the sample cylinder, thereby to pressurize the sample cylinder; and
a third station positioned to receive the sample cylinder in a third state following discharge of at least a portion of the material sample from the sample cylinder, the third station comprising:
a third mounting fixture attached to the platform proximate the third opening and configured to be attached to the sample cylinder in the third state; and
a third valve positioned proximate the third mounting fixture and configured to provide fluid flow between the sample cylinder and one or more of ventilation ductwork or a receptable.

2. The system of claim 1, further comprising:
a base and a panel connected to one or more of the base or the platform, thereby to provide a material shield between the base and the platform, the panel being substantially transparent; and
a first support connected to the base and at least partially defining a first slot slidably receiving a first end of the panel and a second support at least partially defining a second slot slidably receiving a second end of the panel, thereby to facilitate removal and reattachment of the panel.

3. The system of claim 1, further comprising a grounding assembly positioned to electrically ground one or more of a person handling the sample cylinder, the first station, the second station, or the third station, the grounding assembly comprising one or more of:
(a) an electrically grounded connection bus;
(b) a clamp configured to be attached to one or more of the first station, the second station, or the third station, the clamp being electrically conductive;
(c) a first cable connected to the clamp and the electrically grounded connection bus, the first cable being electrically conductive;
(d) a wearable attachment configured to be attached to the person handling the sample cylinder, the wearable attachment being electrically conductive; or
(e) a second cable connected to the wearable attachment and the electrically grounded connection bus, the second cable being electrically conductive.

4. The system of claim 1, further comprising:
a base having a first end and a second end opposite the first end;
a panel connected to one or more of the base or the platform, thereby to provide a material shield between the base and the platform; and
a bleed tube connected to the first valve and extending in a direction away from the panel.

5. The system of claim 1, further comprising a vent tube connected to the at least partially transparent receptacle and positioned to provide fluid flow between the at least partially transparent receptacle and ventilation ductwork, thereby to vent gas from the sample cylinder to the ventilation ductwork.

6. The system of claim 1, wherein the third valve comprises a T-valve positioned to provide fluid flow between the sample cylinder and the one or more of the ventilation ductwork or the receptable.

7. The system of claim 1, wherein one or more of the first mounting fixture, the second mounting fixture, or the third mounting fixture comprises a quick-connect connector for connecting to a quick-connect connector of the sample cylinder.

8. The system of claim 1, further comprising:
a base having a first end and a second end opposite the first end;
a first upright connected proximate the first end of the base; and
a second upright connected proximate the second end of the base, the platform being connected to the first upright and the second upright,
wherein one or more of:
(a) the first valve is positioned opposite the platform relative to the first mounting fixture and is configured to provide fluid flow between the sample cylinder and the space;
(b) the second valve is positioned opposite the platform relative to the second mounting fixture; or
(c) the third valve positioned opposite the platform relative to the third mounting fixture.

9. The system of claim 1, wherein the first station, the second station, and the third station form a unitary structure.

10. The system of claim 1, wherein the at least partially transparent receptacle is oriented such that an axis of the at least partially transparent receptacle is substantially horizontal.

11. The system of claim 1, further comprising a pressure gauge in fluid communication with the at least partially transparent receptacle.

12. The system of claim 1, wherein the sample cylinder comprises a liquid petroleum gas (LPG) sample cylinder.

13. A system for enhancing handling of a sample cylinder, the system comprising:
(a) a first station positioned to receive a sample cylinder in a first state in which the sample cylinder contains a material sample, the first station comprising:
an at least partially transparent receptacle configured to be attached to the sample cylinder and facilitate inspection of at least a portion of the material sample; and
a first valve positioned to provide fluid flow from the sample cylinder, thereby to remove a portion of the material sample from the sample cylinder;
(b) a second station positioned to receive the sample cylinder in a second state following the first state in which the sample cylinder contains the material sample, the second station comprising a second valve positioned to provide fluid flow between a source of pressurized gas and the sample cylinder, thereby to pressurize the sample cylinder; and
(c) a third station positioned to receive the sample cylinder in a third state following discharge of at least a portion of the material sample from the sample cylinder, the third station comprising a third valve positioned to provide fluid flow between the sample cylinder and one or more of ventilation ductwork or a receptable.

14. The system of claim 13, further comprising:
a base and a panel connected to the base, thereby to provide a protective material shield between the system and a person handling the sample cylinder, the panel being at least partially transparent; and
a first support connected to the base and at least partially defining a first slot slidably receiving a first end of the panel and a second support at least partially defining a second slot slidably receiving a second end of the panel, thereby to facilitate separation of the panel from the base and mounting of the panel to the base.

15. The system of claim 13, further comprising a grounding assembly positioned to electrically ground one or more of a person handling the sample cylinder, the first station, the second station, or the third station, the grounding assembly comprising:
an electrically grounded connection bus; and
one or more of:
(a) a clamp configured to be attached to one or more of the first station, the second station, or the third station, the clamp being electrically conductive; and a first cable connected to the clamp and the electrically grounded connection bus, the first cable being electrically conductive; or
(b) a wearable attachment configured to be attached to the person handling the sample cylinder, the wearable attachment being electrically conductive; and a second cable connected to the wearable attachment and the electrically grounded connection bus, the second cable being electrically conductive.

16. The system of claim 13, further comprising:
a base having a first end and a second end opposite the first end;
a panel connected to the base, thereby to provide a protective material shield between the system and a person handling the sample cylinder;
a bleed tube connected to the first station and extending in a direction away from the panel; and
a vent tube connected to the at least partially transparent receptacle and positioned to provide fluid flow between the at least partially transparent receptacle and ventilation ductwork, thereby to vent gas from the sample cylinder to the ventilation ductwork.

17. The system of claim 13, wherein one or more of:
(a) the third valve comprises a T-valve positioned to provide fluid flow between the sample cylinder and the one or more of the ventilation ductwork or the receptable; or
(b) one or more of the first station, the second station, or the third station comprises a quick-connect connector for connecting to a quick-connect connector of the sample cylinder.

18. The system of claim 13, further comprising:
a base having a first end and a second end opposite the first end;
a first upright connected proximate the first end of the base;
a second upright connected proximate the second end of the base; and
a platform associated with one of more of the first station, the second station, or the third station, the platform being connected to the first upright and the second upright,
wherein one or more of:
(a) the first valve is positioned opposite the platform relative to the first station and configured to provide fluid flow between the sample cylinder and a space between the platform and the base;
(b) the second valve is positioned opposite the platform relative to the second station; or
(c) the third valve positioned opposite the platform relative to the third station.

19. The system of claim 13, wherein the first station, the second station, and the third station form a unitary structure.

20. The system of claim 13, further comprising one or more of:
(a) a first mounting fixture associated with the first station and configured to be attached to the sample cylinder in a first state in which the sample cylinder contains a material sample;
(b) a second mounting fixture associated with the second station and configured to be attached to the sample cylinder in a second state following the first state in which the sample cylinder contains the material sample; or
(c) a third mounting fixture associated with the third station and configured to be attached to the sample cylinder in a third state following discharge of at least a portion of the material sample from the sample cylinder.

21. A method for enhancing handling of a sample cylinder, the method comprising:
associating a sample cylinder containing a material sample with a system for handling a sample cylinder;
inspecting the material sample contained in the sample cylinder;
pressurizing the material sample in the sample cylinder;
connecting the sample cylinder to a ventilation hood, thereby to provide selective fluid flow from the sample cylinder to the ventilation hood; and
purging the material sample from the sample cylinder, thereby to release at least a portion of material sample to the ventilation hood.

22. The method of claim 21, wherein inspecting the material sample comprises viewing at least a portion of the material sample, and one or more of:
(a) the viewing of the at least a portion of the material sample comprises passing the at least a portion of the material sample into at least partially transparent receptacle;
(b) the method further comprises determining, via the viewing of the at least a portion of the material sample, whether the sample cylinder contains one or more of particulates, sludge, or water; or
(c) the method further comprises:
determining, via the viewing of the at least a portion of the material sample, whether the sample cylinder contains a greater volume of the material sample than a predetermined maximum volume relative to the volume of the sample cylinder; and
draining, when the sample cylinder contains a greater volume of the sample than the predetermined maximum volume, a portion of the material sample from the sample cylinder until the volume of the material sample is less than the predetermined maximum volume.

23. The method of claim 21, further comprising venting a gaseous portion of the material sample via a ventilation hood.

24. The method of claim 21, wherein the pressurizing of the material sample in the sample cylinder comprises connecting the sample cylinder to a source of pressurized gas, thereby to provide selective fluid flow from the source of pressurized gas to the material sample contained in the sample cylinder.

25. The method of claim 21, further comprising, following pressurizing the material sample in the sample cylinder, testing the material sample via sample testing equipment.

26. The method of claim 21, wherein purging the material sample from the sample cylinder comprises causing gaseous material remaining in the sample cylinder to flow to ductwork of the ventilation hood.

27. The method of claim 21, further comprising causing liquid material in the sample cylinder to flow from the sample cylinder to a receptacle positioned to collect the liquid material.

28. The method of claim 21, further comprising electrically grounding one or more of the system for handling the sample cylinder or the sample cylinder, the electrically grounding of the one or more of the system for handling the sample cylinder or the sample cylinder comprising electrically connecting the one or more of the system for handling or the sample cylinder to a grounded bus bar.

29. The method of claim 21, further comprising electrically connecting a person handling the sample cylinder to a grounded bus bar, thereby to electrically ground the person, the electrically connecting of the person handling the sample cylinder to the grounded bus bar comprising attaching an electrically conductive strap to the person and the grounded bus bar.

30. A method for enhancing handling of a sample cylinder, the method comprising:
connecting a first end of a sample cylinder containing a material sample with a first connector connected to a platform to facilitate inspection of the material sample;
connecting a second end of the sample cylinder to an at least partially transparent receptacle to facilitate inspection of the material sample;
disconnecting the second end of the sample cylinder from the at least partially transparent receptacle;
disconnecting the first end of the sample cylinder from the first connector;
connecting the sample cylinder to a second connector connected to the platform, the second connector being in fluid communication with a gas supply valve positioned to provide fluid flow between a source of pressurized gas and the second connector;
opening the gas supply valve to pressurize the material sample in the sample cylinder;
closing the gas supply valve to prevent fluid flow between the source of pressurized gas to the second connector;
disconnecting the sample cylinder from the second connector;
connecting one of the first end of the sample cylinder or the second end of the sample cylinder to a third connector connected to the platform, the third connector being in fluid communication with a ventilation hood; and
purging the material sample from the sample cylinder, thereby to release at least a portion of the material sample to the ventilation hood.
